(19) United States
(12) Patent Application Publication
(10) Pub. No.: US 2009/0240024 A1
(43) Pub. Date: Sep. 24, 2009

(54) BIAXIALLY ORIENTED POLYESTER FILM AND PREPARATION THEREOF

(75) Inventors: Nam-Il Kim, Kyungki-do (KR); Sang-ll Kim, Kyungki-do (KR); Kyung-Yon Kim, Kyungki-do (KR); Taebyoung Oh, Seoul (KR); Youngwon Kim, Kyungki-do (KR)

Correspondence Address: David A. Einhorn, Esq.;Baker & Hostetler LLP, 45 Rockefeller Plaza, New York, NY, 10111, US

(73) Assignee: SKC CO., LTD., Suwon-si (KR)

(21) Appl. No.: 11/573,479

(22) PCT Filed: Mar. 22, 2005
(86) PCT No.: PCT/KR2005/000826

§ 371 Date: Feb. 9, 2007

(30) Foreign Application Priority Data
Sep. 2, 2004 (KR) 10-2004-0069912
Jan. 6, 2005 (KR) 10-2005-0001079

(51) Int. Cl. C08G 63/183; C08G 63/88

(52) U.S. Cl. 528/308.8; 528/308.6

(57) ABSTRACT

A biaxially oriented polyester film of the present invention which comprises a polyester resin prepared by polymerizing a glycol component mainly comprising 1,3-propanediol and an acid component mainly comprising terephthalic acid or dimethyl terephthalate, said polyester film having an unit impact absorption energy of 1.0 or more, can be advantageously used for packaging.

### FIELD OF THE INVENTION

The present invention is directed to a biaxially oriented polyester film which is useful for packaging and preparation thereof.

### BACKGROUND OF THE INVENTION

High impact strength is required of wrapping material compounds for food and other goods. For this purpose, biaxially oriented nylons, polyethyleneterephthalates and polypropylenes have been employed. Biaxially oriented nylon films have good impact strength at low temperature and high pin-hole resistance, but are disadvantageous in that they are hygroscopic (unsatisfactory for long-term storage) and are hampered by poor printability due to non-uniform thickness of the film. On the other hand, biaxially oriented polyethyleneterephthalate films and biaxially oriented polypropylene films have good printability and excellent heat resistance along with high dimensional stability. However, these materials show poor impact strength and pin-hole resistance.

### SUMMARY OF THE INVENTION

Accordingly, it is an object of the present invention to provide a biaxially oriented polyester film having excellent moisture-resistance, printability, impact strength, pin-hole resistance, conformity to the shape processing and processability at a low temperature, which can be effectively used for packaging, and preparation thereof.

In accordance with the present invention, there is provided a biaxially oriented polyester film prepared from a polyester resin obtained by polymerizing a glycol component comprising 1,3-propanediol as a major component with an acid component comprising terephthalic acid or dimethyl terephthalate as a major component, the resulting polyester film having a unit impact absorption energy of 1.0 or more.

### DETAILED DESCRIPTION OF THE INVENTION

A biaxially oriented polyester film in accordance with the present invention is prepared by polymerizing a glycol component and an acid component. Preferably, 50 mole % or more of the glycol component is 1,3-propanediol. Also, it is preferable that 85 mole % or more of the acid component is terephthalic acid or dimethyl terephthalate, and 15 mole % or less of the acid component is a linear aliphatic dibasic acid having 2 or more carbons.

According to the preferred embodiment of the present invention, the biaxially oriented polyester film can be manufactured by the following procedures. First, film composition satisfying the component contents described above is prepared. Next, the composition thus prepared is melt-extruded, and then quenched to be a cast sheet. The cast sheet is drawn at a ratio of 2 to 4 in the longitudinal direction and at a ratio of 3 to 5 in the transverse direction before heat-setting at a temperature range of 180 to 225° C.

The glycol component for use in the inventive biaxially oriented polyester film includes 50 mole % or more, preferably 70 mole % or more of a 1,3-propanediol. If the amount of the 1,3-propanediol with respect to total glycol component is less than 50 mole %, the impact strength and pin-hole resistance of the resulting film may not be satisfactory.

50 mole % or less, preferably 30 mole % or less of the glycol component for use in the inventive polyester film is selected from the group consisting of 2,2-dimethyl-1,3-propanediol(neopentylglycol), 2-methyl-1,3-propanediol, 1,2-propanediol(propyleneglycol), ethyleneglycol, 1,4-butanediol, 1,5-pentanediol, 1,6-hexanediol, polyethyleneglycol (PEG) and a mixture thereof. If the amount of 2,2-dimethyl-1,3-propanediol, 2-methyl-1,3-propanediol or 1,2-propanediol exceeds 50 mole % of the total glycol component, the crystallization process of the film becomes so slow that the film forming process is adversely affected. Also, this has bad effects on dimensional stability and heat resistance of the film. If the amount of the linear glycol component having 4 or more carbons such as 1,4-butanediol, 1,5-pentanediol, 1,6-hexanediol and polyethyleneglycol (PEG) exceeds 50 mole %, the film thermal characteristics decline even though the flexibility of the film may increase. Further, if the amount of ethyleneglycol exceeds 50 mole % of the total glycol component, the impact strength and flexibility of the film become poor.

The film may further comprise a diethyleneglycol, triethyleneglycol or 1,4-cyclohexanedimethanol as glycol component to the extent they do not adversely affect the film properties.

Further, an acid component is needed in polymerizing the inventive biaxially oriented polyester film. 85 mole % or more, preferably 90 mole % or more of the acid component is terephthalic acid or dimethyl terephthalate. 15 mole % or less, preferably 10 mole % or less of the acid component is linear aliphatic dibasic acid having 2 or more carbons.

The addition of linear aliphatic dibasic acids having 2 or more carbons improves the flexibility of the film, thereby raising the film's impact strength, pin-hole resistance and processability. However, if this amount exceeds 15 mole % of the acid component, the thermal characteristics becomes poor and the film drawing is adversely affected. Examples of such an aliphatic dibasic acid are succinic acid, glutaric acid, adipic acid, suberic acid, azelaic acid, sebacic acid and esters thereof.

The film may further include, e.g., naphthalenedicarboxylic acid or isophthalic acid as an acid component to the extent they do not deteriorate the properties of the film.

The polyester film composition may be obtained by copolymerizing monomer components or blending polymers.

The film of the present invention may include suitable amounts of inorganic particles e.g., calcium carbonate, alumina or silica gel particles with average particle diameter of 0.1-10.0 μm as running enhancer (lubricants) although the influence of these materials on the optical characteristics of the film must be taken into account.

The inventive biaxially oriented polyester film can be manufactured as follows. First, a polyester resin having a desired composition is subjected to melt-extrusion, which is then quenched to be a cast sheet. The cast sheet is drawn to a ratio of 2 to 4, preferably, 2.5 to 3.5 in the longitudinal direction and to a ratio of 3 to 5, preferably, 3.4 to 3.9 in the transverse direction. The drawings in the transverse and longitudinal directions can be performed in one or two steps. The film's impact strength and thickness uniformity are adversely affected if the longitudinal or transverse drawing ratio is less than 2 or 3, respectively. On the other hand, the processability as well as the impact strength of the film becomes poor if the longitudinal or transverse drawing ratio is more than 4 or 5, respectively.

The film drawn both in the longitudinal and transverse directions is heat-set at a temperature in the range of 180 to 225° C., preferably, 185 to 215° C. before being quenched so that satisfactory dimensional stability can be attained. If the film is heat-set at a temperature below 180° C., desired dimensional stability cannot be achieved. Further, if the film is heat-set at a temperature above 225° C., the impact strength becomes low.

When manufacturing a conventional polyethyleneterephthalate or a film comprising polyethyleneterephthalate as its main component, heat-setting is conducted right after drawing and then quenching is performed for relaxation. However, when polytrimethyleneterephthalate is employed as the main component of the film as in the present invention, a high level of shrinkage stress can be formed during the drawing process and such stress causes failure of the film during heat-setting. Accordingly, it is preferable that heat-setting is conducted after the relaxation step so that the shrinkage stress formed during drawing process is relieved prior to heat application. Such being the case, the relaxation step comes first after drawing when polytrimethyleneterephthalate is employed as the main component of the film. The relaxation step can be conducted at a relaxation rate of 7-14% at a temperature in the range of 140-180° C.

After heat-setting, the film can be just quenched at a temperature below 50° C. or subjected to further relaxation as needed. For instance, since the longitudinal property of the final film product may be adversely affected by excessive relaxation right after drawing, the relaxation may be conducted in two steps, adding a second relaxation step during the quenching period after heat-setting, to lower the first relaxation rate right after drawing, thereby minimizing the deterioration of the longitudinal property of the film. The condition of the second relaxation step may be the same as the first one, which is conducted at a relaxation rate of 7-14% at a temperature range of 140-180° C.

The polytrimethyleneterephthalate-based biaxially oriented polyester films of the present invention manufactured by the above process may have a thickness of 7-30 μm (but is not limited thereto).

A polyester film in accordance with the present invention has a unit impact absorption energy of 1.0 or more and, preferably, generates 25 or less pin-holes after being subjected to repeated stress at ambient temperature. A film having a unit impact absorption energy of less than 1.0 cannot be used as a high capacity pouch for a good weighing 500 g or more. Further, if the number of pin-holes exceeds 25 in a test, the film may be susceptible to actual pin-hole generation during transportation. Further, when treated with heat in an air-circulation oven at 150° C. for 30 minutes, a film of the present invention shows 8% or less, preferably 5% or less, more preferably 3% or less heat shrinkage in either the longitudinal or transverse direction. If such heat shrinkage of a film exceeds 8%, it causes problems during the printing, laminating and thermal bonding processes.

Most importantly, if a film is manufactured by conducting relaxation after drawing (but before heat-setting) in the transverse and longitudinal directions, the degree of elongation in the longitudinal and transverse directions is lowered by 30% or less, preferably 20% or less when heated at 180° C. for two seconds. Accordingly, when this film material is used in a bag packaging, pin-hole production can be minimized at the boundaries between the thermal bonding and non-thermal bonding regions. Thus, good sealing properties along with excellent drop impact strength can be obtained.

As shown above, the biaxially oriented polyester films of the present invention can be efficiently used as a wrapping film due to its superior moisture-resistance, impact strength, processability, conformity to the shape wrapping and flexibility in addition to its excellent mechanical strength, dimensional stability and printability. Further, the inventive film may be advantageously used as a laminated wrapping material in the form of one or more polymer layers/metal layers being laminated thereon.

The present invention is further described and illustrated in Examples, which are, however, not intended to limit the scope of the present invention.

### Preparation Example

In the Preparation Examples of the present invention, an esterification reactor equipped with a stirrer operable at 200 rpm and a packed separation tower for the separation of 1,3-propanediol and water from the reaction discharges were used together with a separate reactor equipped with an inverter-type stirrer operable at 10-50 rpm, a condenser for condensing discharges, a polymerization reactor having suction pump.

The properties of the polymers manufactured in the Preparation Example were measured as follows.

(1) Intrinsic Viscosity

The intrinsic viscosity was measured according to a typical intrinsic viscosity measuring procedure at a temperature of 30° C. using a polyethyleneterephthalate sample dissolved in orthochlorophenol.

(2) Composition

A polymer sample dissolved in a 4:1 mixture of deutro-chloroform and trifluoroacetic acid was subjected to quantitative NMR analysis with JSM-LA300 Type ¹H-NMR (Jeol Inc., Japan). Relative areas of characteristic peaks based on a read out were converted into mole %. Some of the compositions gave values different from calculated values, which was judged to have originated from non-homogeneous mixing of constituents polymers.

(3) Melting Point

DSC (Perkin-Elmer Inc.) analysis was performed at a temperature elevation rate of 10° C./min. The glass transition temperature (Tg, ° C.) was determined from the first peak in the heat absorption curve. The next peak in the curve corresponded to the crystallization temperature (Tc, ° C.) and the third heat absorption peak, to the melting point (Tm, ° C.).

### Preparation Example 1

### Polytrimethyleneterephthalate (Polymer A)

For 100 parts by mole of terephthalic acid, 130 parts by mole of 1,3-propanediol were put into an esterification reactor along with a catalyst. The catalyst employed was tributylene titanate, the amount thereof being 0.07 weight % with respect to terephthalic acid. The reactor was pressurized to about 1.3 kg/cm² and its temperature was elevated to 260° C., to conduct esterification reaction at that temperature for about 4 hours. Next, trimethylphosphate (a stabilizer) in the amount of 0.06 weight % with respect to terephthalic acid was mixed with the esterification reactants. Also, a silica powder having an average particle diameter of 2.5 μm (a slip agent) was added thereto in an amount of 0.07 weight % with respect to terephthalic acid. The mixture was then agitated for 5 minutes and transferred to a polymerization reactor. The polymerization reactor was maintained at 265° C. and subjected to slow evacuation. The polymerization reaction continued therein until the agitator motor uses up a measured amount of electrical power. The polymer product was recovered in the form of pellets (intrinsic viscosity: 0.86).

### Preparation Example 2

### Adipic Acid Copolymer (Polymer B)

As shown in Table 1, for 100 parts by mole of the combined sum of terephthalic acid (TPA) and adipic acid (AA), 130 parts by mole of 1,3-propanediol were put into an esterification reactor along with a catalyst. The catalyst employed was tributylene titanate, the amount thereof being 0.07 weight % with respect to terephthalic acid. The reactor was pressurized to about 1.2 kg/cm² and its temperature was elevated to 260° C. to conduct an esterification reaction at that temperature about 4 hours. Next, trimethylphosphate (a stabilizer) in the amount of 0.06 weight % with respect to terephthalic acid was mixed with the esterification reactants. Also, a silica powder having an average particle diameter of 2.5 μm (a slip agent) was added thereto in an amount of 0.07 weight % with respect to terephthalic acid. The mixture was then agitated for 5 minutes and transferred to a polymerization reactor. The polymerization reactor was maintained at 250° C. and subjected to slow evacuation. The polymerization reaction continued therein until the agitator motor uses up a measured amount of electrical power. The polymer product was recovered in the form of pellets.

Characteristics of the pellets, thus obtained, are shown in Table 1 below.

TABLE 1

| | | | | | | Intrinsic | |
|---|---|---|---|---|---|---|---|
| | | | | | | Viscosity | Composition |
| | AA | TPA | Tg(° C.) | Tc(° C.) | Tm(° C.) | (g/dl) | (Mole %) |
| B-1 | 5 | 95 | 36.23 | 63.2 | 217.3 | 0.861 | 4 |
| B-2 | 10 | 90 | — | 59.8 | 216.2 | 0.843 | 9 |
| B-3 | 15 | 85 | — | 55.2 | 210.6 | 0.831 | 13 |
| B-4 | 30 | 70 | — | — | 187.5 | 0.769 | 28 |

### Preparation Example 3

### Polybutyleneterephthalate (Polymer C)

LUPOX HV-1010® (manufactured by LG Chemicals Inc.) was employed as polybutyleneterephthalate.

### Preparation Example 4

### Polyethyleneterephthalate (Polymer D)

For 100 parts by mole of terephthalic acid, 130 parts by mole of ethylene glycol were put into an esterification reactor. The reactor was pressurized to 1.2 kg/cm² and its temperature was elevated to 260° C., to conduct an esterification reaction at that temperature for about 4 hours. Antimony trioxide (a polymerizing catalyst) and trimethylphosphate (a stabilizer) were added to the esterification reactants for mixing therein, in the amounts of 450 ppm and 400 ppm with respect to terephthalic acid, respectively. Also, a silica powder having an average particle diameter of 2.5 μm (a slip agent) was added thereto in an amount of 0.07 weight % with respect to terephthalic acid. The mixture was then agitated for 5 minutes and transferred to a polymerization reactor. The polymerization reactor was maintained at 289° C. and subjected to slow evacuation. The polymerization reaction continued therein for 3 hours and 20 minutes. The intrinsic viscosity of the polymer product was 0.64.

### Preparation Example 5

### 2-methyl-1,3-propanediol copolymer (Polymer E)

The procedure of Preparation Example 2 was repeated except that “130 parts by mole of ethylene glycol” was replaced by “80 parts by mole of 1,3-propanediol and 50 parts by mole of 2-methyl-1,3-propanediol.” The resulting polymer product was recovered in the form of pellets (intrinsic viscosity: 0.84).

### Preparation Example 6

### 2,2-dimethyl-1,3-propanediol copolymer (Polymer F)

The procedure of Preparation Example 2 was repeated except that “130 parts by mole of ethylene glycol” was replaced by “80 parts by mole of 1,3-propanediol and 50 parts by mole of 2,2-dimethyl-1,3-propanediol.” The resulting polymer product was recovered in the form of pellets (intrinsic viscosity: 0.76).

### Preparation Example 7

### 1,2-propanediol copolymer (Polymer G)

The procedure of Preparation Example 2 was repeated except that “130 parts by mole of ethylene glycol” was replaced by “80 parts by mole of 1,3-propanediol and 50 parts by mole of 1,2-propanediol.” The resulting polymer product was recovered in the form of pellets (intrinsic viscosity: 0.81).

### Experimental Example

Using the polymers prepared in Preparation Examples, films were manufactured in accordance with the procedures shown in Examples and Comparative Examples. The properties of the produced film were measured by the following methods, except when the film sample was not smooth or subject to breakage.

(1) Unit Impact Absorption Energy

The unit impact absorption energy was measured according to ASTM D 3420 with Film Impact Tester (Toyoseiki Inc.). The Pendulum tip used was in the form of hemisphere with a diameter of 1 inch. A sample film was fitted on the sample fixture having a 50 mm-diameter circular hole. The impact absorption energy (kgf-cm), thus measured, was divided by the sample film thickness (μm) to determine the unit impact absorption energy (kgf-cm/μm). An average value derived from 10 tests was taken to represent each sample.

(2) Pin-Hole Resistance

A sample film was rotated around using Gelbo Flex (Gelbo Inc., USA) at an angle of 420 degree for 2700 cycles (about 60 minutes). Next, the sample film was placed flat on a white paper, whereon an oily ink was applied with a doctor blade. The numbers of ink dots appeared on the white paper was represented as the pin-hole number. An average value derived from 3 tests was taken to represent each sample.

(3) Drawing

The thickness and breakage of a drawn film were assessed by the following standards.

◯ Good: The average variation in the thickness was less than ±5%, showing uniform drawing.

Δ Decent: The average variation in the thickness was less than ±10%, showing relatively uniform drawing.

x Poor: The average variation in the thickness was ±10% or more, or breakage occurred during drawing.

(4) Heat Shrinkage

A sample having the size of 200 mm long and 15 mm wide was maintained at 150° C. in a circulating air oven for 30 minutes, as the changes in the film length was measured. Using the following equation, the shrinkage in the longitudinal and transverse directions were calculated.

Shrinkage(%)=(Length before heat treatment−Length after heat treatment)/Length before heat treatment×100

(5) Strength and Elongation

The strength and elongation were measured according to ASTM D 288 using a film sample having the size of 100 mm long and 15 mm wide with Universal Tester (UTM 4206-001, Instron Inc.). The interval between chucks was set at 50 mm, and the elongation speed at 200 mm/min. The strength at 100% elongation was represented by F-100 (kg/mm²). The elongation at breakage was marked with a breakage elongation (%) value, and the strength at breakage, with a breakage strength (kg/mm²).

(6) Free Fall Rupture Test

A conventional PET film with a thickness of 12 μm and a conventional laminating aluminum layer of 9±1 μm thickness were laminated on one side of a sample film surface. A casting polypropylene was laminated on the other side thereof. Next, a pouch with 1300 ml capacity was manufactured so that the casting-propylene-laminated-side becomes the inside of the pouch. The pouch included a bottom paper so that it can stand by itself when filled with a merchandise. 1000 ml of water was put into the pouch and the pouch was sealed by heating. Then the pouch was stored in a refrigerator maintained at 5° C. for two days. A box made of a conventional corrugated cardboard of about 5 mm thickness was used to hold 10 such pouches, and it was subjected to free fall on a concrete floor varnished with an epoxy. Such a test was repeated 10 times and the average condition of the pouch was recorded by the following standards.

◯ Good: Less than 4 ruptured.

Δ Decent: 4 or more and less than 7 ruptured.

x Poor: 7 or more ruptured.

(7) Shape Processability

The low density polyethylene IDPE) having a thickness of about 190 μm was subjected to extrusion lamination with a sample film. Three edges thereof were sealed by heating so that the laminated film took the shape of an envelope having a dimension of 200 nm×150 nm. The above process was conducted such that the LDPE laminated side became the inside of the envelope. A wooden hexahedron having a dimension of 50 mm×50 mm×15 mm was placed in the envelope, the envelope was evacuated for 20 seconds, and sealed by heating with small vacuum sealing machine having a built-in vacuum pump at an exhaustion rate of about 10 L/min. Next, the envelope was left at ambient temperature for an hour and the space between the envelope and wooden hexahedron was measured, as graded according to the following standards.

◯ Good: Space was less than 3 mm.

Δ Decent: Space was 3 mm or more and less than 7 mm.

x Poor: Space was 7 mm or more.

(8) Elongation Degradation

A sample film was heated with a thermal adhesion tester (TP701S; Tester Sangyo Co., Japan) to 180° C. under a pressure of 0.2 MPa for 2 seconds. The sample was then elongated at a rate of 200 mm/min by the procedures shown in ASTM D882 using Universal Tester (UTM 4206-001, Instron Inc.) and the degree of elongation was measured. Using the equation shown below, the elongation degradation was calculated in the longitudinal and transverse directions. An average value derived from 5 tests was taken for each sample. Since the intrinsic instrumental error is in the range of ±5%, no elongation degradation was reported when it was less than 5%.

Elongation degradation(%)=(Elongation before heating−Elongation after heating)/Elongation before heating×100

(9) Film Forming

The breakage and smoothness of a drawn film were assessed by the following standards.

◯ Good: No breakage, good drawability and a smooth final film product.

Δ Decent: No breakage, but strains present in the final film product.

x Poor: Not fit for continuous production due to the breakage.

### Examples 1 through 16 and Comparative Examples 1 through 9

Table 2 shows the polyester films manufactured by various compositions and process conditions, as their properties are shown in Table 3.

TABLE 2

| | | | | | Film Composition (Mole %) | | | | |
|---|---|---|---|---|---|---|---|---|---|
| | Polymer Mix Ratio (Weight %) | | | | Acid Component | | Diol Component | | |
| | Polymer A | Polymer B | Polymer C | Polymer D | TPA | AA | EG | PDO | BDO |
| Comparative | 100 | — | — | — | 100 | — | — | 100 | — |
| Example 1 | | | | | | | | | |
| Example 1 | 100 | — | — | — | 100 | — | — | 100 | — |
| Comparative | 100 | — | — | — | 100 | — | — | 100 | — |
| Example 2 | | | | | | | | | |
| Comparative | 100 | — | — | — | 100 | — | — | 100 | — |
| Example 3 | | | | | | | | | |
| Example 2 | 100 | — | — | — | 100 | — | — | 100 | — |
| Example 3 | 100 | — | — | — | 100 | — | — | 100 | — |
| Example 4 | 100 | — | — | — | 100 | — | — | 100 | — |
| Example 5 | 100 | — | — | — | 100 | — | — | 100 | — |
| Example 6 | 75 | — | 25 | — | 100 | — | — | 74 | 24 |
| Example 7 | 75 | — | 25 | — | 100 | — | — | 74 | 24 |
| Example 8 | 70 | — | 30 | — | 100 | — | — | 71 | 29 |
| Comparative | 75 | — | 25 | — | 100 | — | — | 74 | 24 |
| Example 4 | | | | | | | | | |
| Comparative | 45 | — | 55 | — | 100 | — | — | 47 | 53 |
| Example 5 | | | | | | | | | |
| Example 9 | — | B-1 100 | — | — | 96 | 4 | — | 100 | — |
| Example 10 | — | B-2 100 | — | — | 91 | 9 | — | 100 | — |
| Example 11 | 40 | B-3 60 | — | — | 92 | 8 | — | 100 | — |
| Example 12 | — | B-1 100 | — | — | 96 | 4 | — | 100 | — |
| Comparative | 40 | B-4 60 | — | — | 83 | 17 | — | 100 | — |
| Example 6 | | | | | | | | | |
| Example 13 | 50 | — | 25 | 25 | 100 | — | 26 | 51 | 23 |
| Example 14 | 50 | — | 25 | 25 | 100 | — | 26 | 51 | 23 |
| Example 15 | 50 | — | 25 | 25 | 100 | — | 26 | 51 | 23 |
| Example 16 | 50 | — | 25 | 25 | 100 | — | 26 | 51 | 23 |
| Comparative | 30 | — | — | 70 | 100 | — | 71 | 29 | — |
| Example 7 | | | | | | | | | |
| Comparative | 50 | — | 25 | 25 | 100 | — | 26 | 51 | 23 |
| Example 8 | | | | | | | | | |
| Comparative | — | — | — | 100 | 100 | | 100 | — | — |
| Example 9 | | | | | | | | | |

| | Drawing | | Drawing | | Heat | Film | |
|---|---|---|---|---|---|---|---|
| | Ratio | | Temperature (° C.) | | Fixation | Thick- | |
| | Longi- | Trans- | Longi- | Trans- | Temperature | ness | Film |
| | tudinal | verse | tudinal | verse | (° C.) | (μm) | Drawing |
| Comparative | 2.3 | 2.5 | 55 | 60 | 190 | 12 | X |
| Example 1 | | | | | | | (Non-Uniform |
| | | | | | | | Drawing) |
| Example 1 | 3.0 | 3.2 | 55 | 60 | 195 | 12 | ◯ |
| Comparative | 3.0 | 3.2 | 55 | 60 | 170 | 12 | ◯ |
| Example 2 | | | | | | | |
| Comparative | 4.5 | 4.5 | 55 | 60 | — | | X(Breakage) |
| Example 3 | | | | | | | |
| Example 2 | 3.0 | 3.2 | 55 | 60 | 200 | 12 | Δ |
| Example 3 | 2.5 | 3.4 | 55 | 60 | 190 | 15 | ◯ |
| Example 4 | 2.5 | 3.4 | 55 | 60 | 190 | 20 | ◯ |
| Example 5 | 2.5 | 3.4 | 55 | 60 | 190 | 25 | ◯ |
| Example 6 | 3.5 | 3.5 | 50 | 55 | 200 | 12 | ◯ |
| Example 7 | 3.5 | 3.5 | 50 | 55 | 190 | 12 | ◯ |
| Example 8 | 3.2 | 3.5 | 50 | 55 | 200 | 12 | ◯ |
| Comparative | 4.5 | 4.5 | 50 | 55 | — | | X(Breakage) |
| Example 4 | | | | | | | |
| Comparative | 2.8 | 3.0 | 50 | 55 | 200 | 12 | ◯ |
| Example 5 | | | | | | | |
| Example 9 | 3.2 | 3.3 | 50 | 55 | 185 | 12 | ◯ |
| Example 10 | 3.2 | 3.3 | 50 | 55 | 185 | 12 | ◯ |
| Example 11 | 3.2 | 3.3 | 50 | 55 | 195 | 12 | ◯ |
| Example 12 | 3.2 | 3.3 | 50 | 55 | 185 | 19 | ◯ |
| Comparative | 3.2 | 3.3 | 50 | 55 | 185 | | X |
| Example 6 | | | | | | | (Non-Uniform |
| | | | | | | | Drawing) |
| Example 13 | 3.3 | 3.7 | 65 | 70 | 195 | 12 | ◯ |
| Example 14 | 3.8 | 4.0 | 65 | 70 | 200 | 12 | ◯ |
| Example 15 | 3.3 | 3.7 | 65 | 70 | 195 | 7 | ◯ |
| Example 16 | 3.3 | 3.7 | 65 | 70 | 195 | 9 | ◯ |
| Comparative | 4.0 | 4.2 | 85 | 95 | 230 | 12 | ◯ |
| Example 7 | | | | | | | |
| Comparative | 4.5 | 4.5 | 65 | 70 | — | | X(Breakage) |
| Example 8 | | | | | | | |
| Comparative | 3.5 | 3.8 | 95 | 110 | 220 | 12 | ◯ |
| Example 9 | | | | | | | |

Polymer A: Polytrimethyleneterephthalate (PTT),
Polymer B: Adipic acid Co-polymerized polytrimethyleneterephthalate,
Polymer C: Polybutyleneterephthalate (PBT)
Polymer D: Polyethyleneterephthalate,
TPA: Terephthalic acid,
AA: Adipic acid,
EG: Ethylene glycol,
PDO: 1,3-propanediol,
BDO: 1,4-Butanediol

TABLE 3

| | Mechanical Properties | | | | | | | | Heat | | | | |
|---|---|---|---|---|---|---|---|---|---|---|---|---|---|
| | Breakage | | F-100 | | Elongation at | | Unit Impact | Pin-hole | Shrinkage, % | | Rupture | | |
| | Strength (kg/mm²) | | (kg/mm²) | | Breakage (%) | | Absorption | resistance | (150° C., 30 min) | | after | | |
| | Longi- | Trans- | Longi- | Trans- | Longi- | Trans- | Energy | (Pin-hole | Longi- | Trans- | Free | Shape | Over- |
| | tudinal | verse | tudinal | verse | tudinal | verse | (Kgf-cm/μm) | numbers) | tudinal | verse | fall | Processing | all |
| Comparative | — | — | — | — | — | — | — | — | — | — | — | — | X |
| Example 1 | | | | | | | | | | | | | |
| Example 1 | 22 | 26 | 13 | 15 | 155 | 143 | 1.36 | 4 | 3.3 | 3.1 | ◯ | ◯ | ◯ |
| Comparative | 15 | 18 | 11 | 14 | 145 | 126 | 1.17 | 5 | 10.2 | 13.8 | ◯ | ◯ | X |
| Example 2 | | | | | | | | | | | | | |
| Comparative | — | — | — | — | — | — | — | — | — | — | — | — | X |
| Example 3 | | | | | | | | | | | | | |
| Example 2 | 19 | 21 | 11 | 13 | 157 | 146 | 1.15 | 4 | 2.6 | 3.6 | ◯ | ◯ | ◯ |
| Example 3 | 19 | 23 | 13 | 18 | 178 | 158 | 1.03 | 3 | 3.4 | 3.9 | ◯ | ◯ | ◯ |
| Example 4 | 19 | 22 | 12 | 14 | 177 | 164 | 1.04 | 4 | 3.1 | 4.2 | ◯ | ◯ | ◯ |
| Example 5 | 18 | 23 | 12 | 14 | 182 | 166 | 1.07 | 4 | 3.5 | 5.2 | ◯ | ◯ | ◯ |
| Example 6 | 17 | 19 | 13 | 17 | 161 | 154 | 1.15 | 2 | 3.7 | 4.1 | ◯ | ◯ | ◯ |
| Example 7 | 18 | 21 | 12 | 15 | 157 | 143 | 1.01 | 6 | 3.1 | 2.8 | Δ | Δ | Δ |
| Example 8 | 16 | 18 | 12 | 15 | 162 | 159 | 1.19 | 4 | 2.1 | 2.5 | ◯ | ◯ | ◯ |
| Comparative | — | — | — | — | — | — | — | — | — | — | — | — | X |
| Example 4 | | | | | | | | | | | | | |
| Comparative | 14 | 15 | — | 14 | 84 | 109 | 0.62 | 8 | 1.8 | 2.6 | X | ◯ | X |
| Example 5 | | | | | | | | | | | | | |
| Example 9 | 23 | 25 | 12 | 14 | 172 | 156 | 1.18 | 3 | 5.5 | 7.1 | ◯ | ◯ | ◯ |
| Example 10 | 17 | 21 | 9 | 13 | 171 | 165 | 1.38 | 2 | 5.7 | 6.1 | ◯ | ◯ | ◯ |
| Example 11 | 21 | 22 | 12 | 14 | 182 | 169 | 1.33 | 3 | 3.1 | 4.5 | ◯ | ◯ | ◯ |
| Example 12 | 21 | 23 | 13 | 16 | 175 | 183 | 1.18 | 3 | 4.9 | 5.2 | ◯ | ◯ | ◯ |
| Comparative | — | — | — | — | — | — | — | — | — | — | — | — | X |
| Example 6 | | | | | | | | | | | | | |
| Example 13 | 22 | 24 | 15 | 18 | 192 | 187 | 1.08 | 21 | 2.6 | 3.1 | Δ | ◯ | ◯ |
| Example 14 | 22 | 25 | 16 | 17 | 154 | 135 | 1.15 | 18 | 4.7 | 5.9 | Δ | Δ | ◯ |
| Example 15 | 19 | 21 | 14 | 18 | 188 | 172 | 1.27 | 16 | 2.9 | 3.9 | Δ | ◯ | ◯ |
| Example 16 | 20 | 24 | 15 | 18 | 178 | 169 | 1.14 | 15 | 3.2 | 4.1 | Δ | ◯ | ◯ |
| Comparative | 23 | 25 | — | — | 94 | 78 | 0.79 | 27 | 1.6 | 1.5 | X | X | X |
| Example 7 | | | | | | | | | | | | | |
| Comparative | — | — | — | — | — | — | — | — | — | — | — | — | X |
| Example 8 | | | | | | | | | | | | | |
| Comparative | 21 | 25 | — | — | 89 | 76 | 0.72 | Crack | 2.5 | 2.7 | X | X | X |
| Example 9 | | | | | | | | | | | | | |

As shown in Tables 2 and 3 above, the inventive prepared films in the Examples are clearly superior to those of Comparative Examples in terms of mechanical properties, impact absorption energy, pin-hole resistance, heat shrinkage, rupture after free fall and shape processing.

### Examples 17 through 23

The procedure of Example 1 was repeated except that film was subject to relaxation at 150° C. before heat-setting after the longitudinal and transverse drawing step, to obtain 15 μm-thick films listed in Table 4. The conditions and resulting properties are shown in Tables 4 and 5 below.

TABLE 4

| | | | | | | | | | | | | Drawing |
|---|---|---|---|---|---|---|---|---|---|---|---|---|
| | Polymer Composition (Weight %) | | | | | Film Composition (Mole %) | | | | | | Ratio |
| | Polymer | | | | | Acid Component | | Diol Component | | | | Longi- |
| No. | A | B-4 | E | F | G | TPA | AA | PDO | MPD | NPG | PG | tudinal |
| 17 | 100 | — | — | — | — | 100 | — | 100 | — | — | — | 2.8 |
| 18 | 100 | — | — | — | — | 100 | — | 100 | — | — | — | 2.8 |
| 19 | 50 | 50 | — | — | — | 86 | 14 | 100 | — | — | — | 2.8 |
| 20 | 50 | — | 50 | — | — | 100 | — | 77 | 23 | — | — | 3.0 |
| 21 | 50 | — | — | 50 | — | 100 | — | 91 | — | 9 | — | 2.8 |
| 22 | 50 | — | — | — | 50 | 100 | — | 86 | — | — | 14 | 3.3 |
| 23 | 50 | — | 50 | — | — | 100 | — | 77 | 23 | — | — | 2.6 |

| | | | | | | | Second | |
|---|---|---|---|---|---|---|---|---|
| | | Drawing | | First | | | Relaxation | |
| | Drawing | Temperature | | Relaxation | | | (When Cooling) | |
| | Ratio | (° C.) | | Temper- | Relax- | Heat-Setting | Temper- | Relax- |
| | Trans- | Longi- | Trans- | ature | ation | Temperature | ature | ation |
| No. | verse | tudinal | verse | (° C.) | Rate (%) | (° C.) | (° C.) | Rate (%) |
| 17 | 3.6 | 55 | 60 | 150 | 7 | 190 | — | — |
| 18 | 3.6 | 55 | 90 | 150 | 9 | 200 | — | — |
| 19 | 3.5 | 50 | 55 | 150 | 7 | 190 | — | — |
| 20 | 3.6 | 60 | 65 | 150 | 7 | 190 | 140 | 2 |
| 21 | 3.6 | 55 | 60 | 150 | 7 | 190 | — | — |
| 22 | 3.8 | 55 | 65 | 170 | 9 | 195 | — | — |
| 23 | 3.6 | 50 | 55 | 150 | 7 | 205 | 140 | 3 |

TPA: Terephthalic acid,
AA: Adipic acid,
PDO: 1,3-propanediol,
MPD: 2-Methyl-1,3-propanediol
NPG: 2,2-Dimethyl-1,3-propanediol,
PG: 1,2-Propanediol

TABLE 5

| | | Film characteristics | | | | | | | |
|---|---|---|---|---|---|---|---|---|---|
| | | Heat | | Elongation | | Unit impact | | | |
| | | shrinkage, % | | Degradation | | absorption | | | |
| | Film | (150° C., 30 min) | | (%) | | energy | Pin-hole | Rupture at | |
| No. | forming | L | T | L | T | (Kgf-cm/μm) | resistance | free fall | Overall |
| 17 | ◯ | 3.2 | 4.9 | 24 | 27 | 1.13 | 2 | Δ | ◯ |
| 18 | ◯ | 2.7 | 3.1 | 19 | 15 | 1.33 | 3 | ◯ | ◯ |
| 19 | ◯ | 3.5 | 4.7 | 24 | 21 | 1.20 | 1 | ◯ | ◯ |
| 20 | ◯ | 4.1 | 3.2 | None | None | 1.27 | 4 | ◯ | ◯ |
| 21 | ◯ | 2.9 | 2.8 | None | None | 1.00 | 1 | ◯ | ◯ |
| 22 | ◯ | 2.1 | 3.9 | 10 | 13 | 1.13 | 3 | ◯ | ◯ |
| 23 | ◯ | 1.9 | 3.6 | None | None | 1.00 | 2 | ◯ | ◯ |

L: Longitudinal
T: Transverse

From the results of Tables 4 and 5, it can be confirmed that films subjected to a relaxation step before heat-setting undergoes less elongation degradation in the longitudinal and transverse directions while heating.

While the invention has been described with respect to the above specific embodiments, it should be recognized that various modifications and changes may be made to the invention by those skilled in the art which also fall within the scope of the invention as defined by the appended claims.

What is claimed is:

1. A biaxially oriented polyester film manufactured from a polyester resin, prepared by polymerizing a glycol component mainly comprising 1,3-propanediol, and an acid component mainly comprising terephthalic acid or dimethyl terephthalate, the polyester film having a unit impact absorption energy of 1.0 or more.

2. The film of claim 1, wherein 50 mole % or more of the glycol component is 1,3-propanediol.

3. The film of claim 1, wherein 85 mole % or more of the acid component is terephthalic acid or dimethyl terephthalate.

4. The film of claim 1, wherein 50 mole % or less of the glycol component is selected from the group consisting of 2,2-dimethyl-1,3-propanediol, 2-methyl-1,3-propanediol, 1,2-propanediol, ethyleneglycol, 1,4-butanediol, 1,5-pentanediol, 1,6-hexanediol, polyethyleneglycol and a mixture thereof.

5. The film of claim 1, wherein 15 mole % or less of the acid component is a linear aliphatic dibasic acid having 2 or more carbons.

6. The film of claim 5, wherein the aliphatic dibasic acid is selected from the group consisting of succinic acid, glutaric acid, adipic acid, suberic acid, azelaic acid, sebacic acid and ester derivatives thereof.

7. The film of claim 1, wherein the pin-hole occurrence is 25 or less after being subjected to repeated stress at ambient temperature.

8. The film of claim 1, wherein the heat shrinkage rates in the longitudinal and transverse directions are both 8% or less when subjected to heat treatment at 150° C. in a circulating air oven for 30 minutes.

9. The film of claim 1, wherein the elongation degradations in the longitudinal and transverse directions are both 30% or less when heated at 180° C. for two seconds.

10. A process of manufacturing the film of claim 1, comprising the steps of:
drawing an undrawn sheet of polyester resin polymerized from a glycol component and an acid component to a ratio of 2 to 4 in the longitudinal direction and to a ratio of 3 to 5 in the transverse direction; and
subjecting the drawn sheet to heat-setting at a temperature range of 180 to 225° C., wherein the glycol component mainly includes 1,3-propanediol and the acid component mainly includes terephthalic acid or dimethyl terephthalate.

11. The process of claim 10, wherein 50 mole % or more of the glycol component is 1,3-propanediol.

12. The process of claim 10, wherein 85 mole % or more of the acid component is terephthalic acid or dimethyl terephthalate.

13. The process of claim 10, wherein 50 mole % or less of the glycol component is selected from the group consisting of 2,2-dimethyl-1,3-propanediol, 2-methyl-1,3-propanediol, 1,2-propanediol, ethyleneglycol, 1,4-butanediol, 1,5-pentanediol, 1,6-hexanediol, polyethyleneglycol and a mixture thereof.

14. The process of claim 10, wherein 15 mole % or less of the acid component is a linear aliphatic dibasic acid having 2 or more carbons.

15. The process of claim 14, wherein the aliphatic dibasic acid is selected from the group consisting of succinic acid, glutaric acid, adipic acid, suberic acid, azelaic acid, sebacic acid and ester derivatives thereof.

16. The process of claim 10, further comprising the step of relaxation between the steps of drawing and heat-setting.

17. The process of claim 16, wherein the relaxation step is conducted at a temperature between 140 and 180° C., relaxation rate being between 7 and 14%.

18. A wrapping material comprising any one of the films of claims 1 through 9.

19. A wrapping material, comprising:
any one of the films of claims 1 through 9 as a substrate; and
an additional polymer layer or metal layer placed on the substrate.
